(19) United States
(12) Patent Application Publication
(10) Pub. No.: US 2011/0030424 A1
(43) Pub. Date: Feb. 10, 2011

(54) METHOD OF MANUFACTURING SUBSTRATE FOR MAGNETIC RECORDING MEDIUM

(75) Inventor: Kazuyuki Haneda, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K.

(21) Appl. No.: 12/937,489

(22) PCT Filed: Apr. 13, 2009
(86) PCT No.: PCT/JP2009/057455

§ 371 Date: Oct. 12, 2010

(30) Foreign Application Priority Data
Apr. 14, 2008 (JP) 2008-104468

(51) Int. Cl. G11B 5/84; C03B 23/037; C03B 33/04

(52) U.S. Cl. 65/105

(57) ABSTRACT

A method of manufacturing a substrate for a magnetic recording medium that is capable of manufacturing a magnetic recording medium substrate having no warping and superior surface smoothness at a high level of productivity and at low cost. The method of manufacturing a substrate for a magnetic recording medium according to the present invention includes a thin glass sheet formation step of heating and softening a sheet-like glass base material (1), and heat-stretching the glass base material (1) while pulling the material downward through space, thereby forming a thin glass sheet (5), a glass substrate formation step of cutting a circular disc-shaped glass substrate from the thin glass sheet (5), and a surface processing step of subjecting the disc-shaped glass substrate to lapping and/or polishing surface processing.

### TECHNICAL FIELD

The present invention relates to a magnetic recording medium used in a hard disk drive or the like, and relates specifically to a method of manufacturing a substrate used in the magnetic recording medium.

Priority is claimed on Japanese Patent Application No. 2008-104468,filed Apr. 14, 2008, the content of which is incorporated herein by reference.

### BACKGROUND ART

A variety of different disks including magnetic disks, magneto-optical disks and optical disks are used as magnetic recording media, but for particularly high capacity magnetic recording media, magnetic disk such as hard disk drives are usually used. An aluminum alloy substrate or glass substrate is usually used as the substrate for this type of magnetic disk. In those cases where a glass is used as the magnetic disk substrate, the hardness, surface smoothness, rigidity and impact resistance are generally superior to those exhibited by an aluminum alloy substrate.

Glass substrates used in magnetic recording media have an external shape composed of a circular disc shape with an opening formed in the center. The spindle of a rotating motor is inserted through this opening in the glass substrate, the magnetic recording medium is then rotated at high speed by the rotating motor, and information is read from, or written onto, the magnetic recording medium using a magnetic recording/reproducing head that floats above the surface of the magnetic recording medium.

A multitude of methods have been proposed as the method of manufacturing the glass substrate for a magnetic recording medium, but those manufacturing methods can be broadly classified into two methods.

The first manufacturing method is a method in which a circular disc-shaped substrate is cut from a large glass sheet. One known method of manufacturing the glass sheet is the down-draw process in which the glass sheet is pulled vertically downward. In one example of the down-draw process, the melted glass flows down both side surfaces of a wedge-shaped molded body, the flows of glass from the two sides merge at the bottom end of the molded body, and the glass is then pulled downward by pulling rollers or the like while gradually cooling, thereby molding a glass sheet (for example, see Patent Document 1).

The second manufacturing method is a method in which the melted glass is subjected to direct press molding using a molding die, a so-called direct press method. This method uses upper and lower molding dies having mold release agent layers formed on the molding surfaces thereof, and by sandwiching the softened raw material glass between the two molding dies, and then performing pressing at a temperature no higher than the softening point of the glass, for a period of time sufficient to allow the upper and lower dies and the glass to reach thermal equilibrium, a disc-shaped glass substrate with minimal warping can be manufactured (for example, see Patent Document 2).

The disc-shaped glass substrate manufactured using one of the methods described above is subsequently subjected to lapping and polishing of the surfaces and end faces. Surface processing of the glass substrate is generally composed of the three stages of primary lapping, secondary lapping, and polishing. The polishing processing may sometimes be conducted in two stages composed of primary polishing and secondary polishing (for example, see Patent Document 3).

All of the glass processing methods described above are processing methods for glass sheets, but another known method used as a method of manufacturing glass fibers and glass tubes is the redraw molding method. The redraw molding method is a method in which a glass material having a similar shape to the desired shape is subjected to hot stretching to mold a product of the desired shape (for example, see Patent Document 4).

[Patent Document 1]

Japanese Unexamined Patent Application, First Publication No. Hei 2-225326

[Patent Document 2]

Japanese Unexamined Patent Application, First Publication No. Hei 5-105458

[Patent Document 3]

Japanese Unexamined Patent Application, First Publication No. 2000-339672

[Patent Document 4]

Japanese Unexamined Patent Application, First Publication No. 2005-53754

### DISCLOSURE OF INVENTION

However, recently there have been increased demands for higher density magnetic recording media, and therefore compared with conventional media, substrates with minimal warping and superior surface smoothness are required. Particularly in the case of substrates for magnetic recording media that are compatible with MR heads, a high degree of flatness is required.

Glass substrates obtained using the press molding method described above are thin sheets, and are therefore prone to warping upon release from the press molding dies. In order to eliminate this warping, multiple stages of lapping and polishing are required.

Furthermore, even in those cases where a glass substrate manufactured by the down-draw process is used, the surface smoothness of the glass sheet is poor, and in order to achieve the high degree of smoothness required for a magnetic recording medium substrate, multiple stages of lapping and polishing are required. As a result, the time required for lapping and polishing lengthens, resulting in a deterioration in the mass production applicability of the magnetic recording medium substrate and an increase in costs.

The present invention takes the above circumstances into consideration, with an object of providing a method of manufacturing a substrate for a magnetic recording medium that is capable of manufacturing a magnetic recording medium substrate having no warping and superior surface smoothness at a high level of productivity and at low cost.

As a result of intensive investigation aimed at achieving the above object, the inventors of the present invention discovered that by using a glass sheet manufactured by a redraw molding method as the glass sheet that acts as the base material for forming a substrate for a magnetic recording medium, warping of the glass sheet could be reduced and the smoothness of the glass surface could be easily improved, and therefore the lapping processing that has been essential in conventional substrate processing methods could be eliminated, resulting in a dramatic improvement in the productivity of the magnetic recording medium substrate, and they were therefore able to complete the present invention. In other words, the present invention relates to the aspects described below.

(1) A method of manufacturing a substrate for a magnetic recording medium, the method including: a thin glass sheet formation step of heating and softening a sheet-like glass base material, and heat-stretching the glass base material while pulling the material downward through space, thereby forming a thin glass sheet, a glass substrate formation step of cutting a circular disc-shaped glass substrate from the thin glass sheet, and a surface processing step of subjecting the disc-shaped glass substrate to lapping and/or polishing surface processing.

(2) The method of manufacturing a substrate for a magnetic recording medium according to (1) above, wherein in the thin glass sheet formation step, the thickness of the thin glass sheet is not more than 110% of the predetermined thickness of the substrate for a magnetic recording medium, and the surface roughness (Ra) of the thin glass sheet is processed to not more than 2 nm.

(3) The method of manufacturing a substrate for a magnetic recording medium according to (1) or (2) above, wherein the surface processing step includes only polishing processing

(4) The method of manufacturing a substrate for a magnetic recording medium according to (3) above, wherein the polishing processing is an one-stage process.

The method of manufacturing a substrate for a magnetic recording medium according to the present invention is capable of manufacturing a magnetic recording medium substrate having no warping and superior surface smoothness at a high level of productivity and at low cost. In other words, during the manufacture of the substrate for a magnetic recording medium, warping of the substrate prior to surface processing is reduced, and the surface roughness can be improved dramatically. As a result, lapping and polishing of the substrate surface can be reduced, enabling a marked improvement in the productivity of the glass substrate for a magnetic recording medium.

### BRIEF DESCRIPTION OF THE DRAWINGS

FIG. 1 is a schematic illustration describing a method of manufacturing a substrate for a magnetic recording medium according to an embodiment of the present invention.

### BEST MODE FOR CARRYING OUT THE INVENTION

The method of manufacturing a substrate for a magnetic recording medium according to the present invention is described below in further detail, with reference to the drawing.

The method of manufacturing a substrate for a magnetic recording medium according to the present invention includes basically a thin glass sheet formation step of heating and softening a sheet-like glass base material, and heat-stretching the glass base material while pulling the material downward through space, thereby forming a thin glass sheet, a glass substrate formation step of cutting a circular disc-shaped glass substrate from the thin glass sheet, and a surface processing step of subjecting the disc-shaped glass substrate to lapping and/or polishing surface processing.

### [Thin Glass Sheet Formation Step]

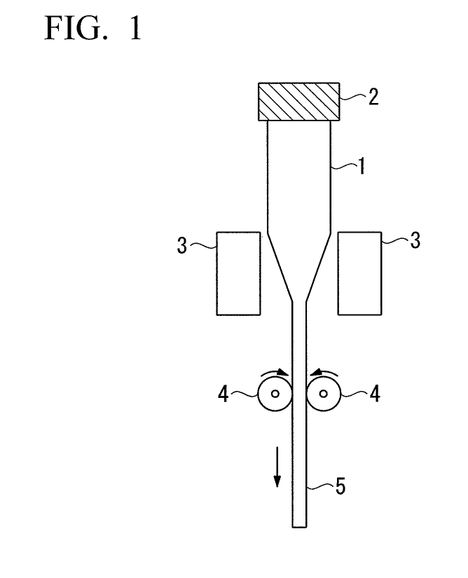

In the method of manufacturing a substrate for a magnetic recording medium according to the present invention, as the method of forming the thin glass sheet that acts as the base material, a method is employed in which a sheet-like glass material is heated and softened, and this glass material is then heat-stretched while being pulled downward through space. This method is known as the redraw molding method, and is described below in detail with reference to FIG. 1.

### (Redraw Molding Method)

As illustrated in FIG. 1, in a glass base material 1 prior to redraw molding, the widthwise direction represents the thickness direction of the glass material, and the lengthwise direction represents the surface direction of the glass material. The cross-section of the glass base material 1 has a shape similar to the cross-section of the magnetic recording medium substrate that is to be molded. The top end of the glass base material 1 is supported by a base material support 2, whereas the bottom end of the glass base material 1 is a free end.

In the manufacturing method of the present invention, the bottom end of the glass base material 1 is converted to a melted state by a heater 3. Subsequently, the melted glass material sags downward under the effect of gravity, and by pulling this sagging glass material further downward by pulling rollers 4, thereby hot stretching the glass base material 1, a thin glass sheet 5 having a similar cross-sectional shape to the glass base material 1 can be produced.

By employing this type of thin glass sheet formation method, a thin glass sheet having a high degree of surface smoothness and minimal strain or warping can be manufactured with comparative ease. In other words, when the method of the present invention is employed, the surface of the glass base material 1 can be smoothed, meaning the thin glass sheet 5 manufactured by pulling and stretching the base material also has a smooth surface. Further, because the surface of the thin glass sheet 5 solidifies in a freely open state, the surface state of the molding die is not transferred to the glass surface as occurs in a press molding method. Moreover, during solidification of the glass, because no external forces are applied to the glass, no strain is incorporated within the solidifying glass, and the glass also suffers no warping. The upper portion of the thin glass sheet 5 contacts the pulling rollers 4, but because the glass is still in a melted state at this point, no strain or the like is incorporated within the thin glass sheet 5 at this point, and any unevenness on the surface of the rollers is not transferred to the thin glass sheet.

In the present invention, during formation of the thin glass sheet 5 using the redraw molding method, the thickness of the glass base material 1, the heating temperature of the bottom end of the glass base material 1, and the pull speed applied to the melted glass base material 1 vary depending on the variety and thickness of the glass base material 1 and the thickness of the thin glass sheet 5 being manufactured, but because the thickness of a substrate for a magnetic recording medium having an external diameter 2.5 inches is approximately 0.635 mm, the thickness of the glass base material 1 may be selected appropriately from within a range from several mm to several cm, the melt temperature for the glass may be selected from within a range from 700 to 900° C., and the pull speed may be selected from within a range from 1 to 10 m/minute.

### [Glass Substrate Formation Step]

Next, a circular disc-shaped glass substrate having an opening in the center is cut from the thin glass sheet 5. Conventional methods may be used as the method of cutting the disc-shaped glass substrate from the thin glass sheet 5, including mechanical processing methods using a hole saw that employs a diamond grindstone, and laser processing methods.

### [Surface Processing Step]

Subsequently, the circular disc-shaped glass substrate is subjected to surface processing using lapping and/or polishing techniques. In the present invention, lapping processing describes the finishing processing used to convert the glass substrate to the predetermined shape and dimension required for the magnetic recording medium substrate. Adjusting the glass substrate to predetermined levels of flatness and surface roughness in this step enables the subsequent polishing step to be conducted more smoothly. In the present invention, lapping of the substrate for the magnetic recording medium may employ a method that uses a lapping plate with fixed abrasive grains, or a method that uses a fixed plate with loose abrasive grains.

On the other hand, polishing processing describes the processing of the lapped product to achieve a nano-level mirror surface. This polishing step is used to impart the glass substrate with the level of precision required in the final product. The polishing of the substrate for the magnetic recording medium may employ a method using loose abrasive grains and a fixed plate.

As described above, there may be some overlap in the methods used for the lapping processing and the polishing processing. In the present invention, for the sake of simplicity, the final finishing processing is referred to as polishing, whereas other processing using fixed abrasive grains is referred to as lapping.

Furthermore, of the other processes using loose abrasive grains, processing in which the thickness of the glass substrate prior to processing is not more than 10% greater than the thickness following processing is defined as polishing, whereas processing in which this change in thickness is greater than 10% is defined as lapping. For example, in the case of a glass substrate for a magnetic recording medium having an outer diameter of 2.5 inches, if the thickness of the final product is 0.635 mm, then processing other than the final step in which the combined machining allowance for both surfaces of the substrate is greater than approximately 0.06 mm (approximately 0.03 mm for each surface) is described as lapping, and processing in which this machining allowance is less than approximately 0.06 mm is described as polishing.

In processing that uses loose abrasive grains, the polishing slurry may sometimes be changed during the polishing process. In this case, a new stage of processing is deemed to start at the point where the polishing slurry is changed.

For the lapping processing, a diamond lapping plate containing diamond grains of several microns to 20 microns may be used. Further, instead of using diamond grains, similarly sized grains of cubic BN, SiC or Al₂O₃ or the like may also be used.

For the polishing processing, a dispersion prepared by dispersing a ceria polishing material and a silica polishing material in a dispersion medium such as water may be used as the polishing slurry that provides the loose abrasive grains.

Examples of ceria polishing materials that can be used for preparing the polishing slurry include commercially available materials, and specific examples include materials having an average grain size of 0.1 to 5 μm, and preferably 0.2 to 1.5 μm.

Examples of silica polishing materials that can be used for preparing the polishing slurry include materials that are available commercially as fumed silica, precipitated silica and colloidal silica, and the use of colloidal silica is particularly desirable. In particular, colloidal silica having a grain size of 0.01 to 0.2 μm can be used. The use of colloidal silica having an average grain size of approximately 0.02 μm (20 nm) is particularly desirable.

Examples of dispersion media that can be used in preparing the slurry include water and organic solvents such as water-soluble organic solvents, but water is the preferred dispersion medium. Specific examples of the water-soluble organic solvent include alcohols such as methanol and ethanol.

The polishing slurry may also include an optional surfactant as a dispersant. Examples of this surfactant include anionic surfactants, cationic surfactants, nonionic surfactants, amphoteric surfactants, and combinations thereof.

A polishing slurry is particularly useful for polishing a crystallized glass substrate having crystalline phase portions and amorphous phase portions. This is because the ceria polishing material of the polishing slurry exhibits a favorable polishing action, via both chemical and mechanical actions, on the amorphous phase portions of the crystallized glass substrate, whereas the silica polishing material of the polishing slurry also exhibits a favorable mechanical polishing action on the crystalline phase portions, for which rapid polishing cannot be achieved using only a ceria polishing material.

Further, the hardness of the silica polishing material is not overly large, and therefore micro-scratches or the like are unlikely to be generated on the surface of the crystallized glass substrate. Furthermore, with a polishing slurry, because a favorable polishing action can be achieved with a relatively low concentration of the polishing material, the cost of the polishing slurry can be reduced.

In those cases where polishing of the glass substrate is conducted using a polishing slurry, by using upper and lower plates covered with polishing cloths as polishing members, sandwiching a plurality of glass substrates supported on a carrier between these polishing members, and then rotating the upper and lower plates, both surfaces of the glass substrates can be polished simultaneously. The polishing slurry may also be used within other polishing methods, including methods using brushes, polishing tapes or polishing pads or the like.

The polishing processing may be conducted once (one stage), or conducted over a plurality of stages. In those cases where the polishing is conducted in one stage, only a final polishing step of smoothing the surfaces of the glass substrate and removing surface defects is performed.

In those cases where the polishing is conducted over a plurality of stages, generally, a rough polishing step of removing process degeneration layers and scratches from the glass substrate surfaces and controlling the edge shape of the glass substrate, and a final polishing step of smoothing the surfaces of the glass substrate and removing surface defects are performed.

In the rough polishing step, a polishing pad (hard polisher) formed from a comparatively hard foamed urethane or the like is used as the polishing member, whereas in the final polishing step, a polishing pad (soft polisher) formed from a comparatively soft synthetic leather suede or the like is used as the polishing member. The polishing member used in combination with the polishing slurry of the present invention in order to polish the glass substrate does not limit the present invention in any way.

For example, as the hard polisher, a urethane pad, nonwoven cloth pad or epoxy resin pad or the like may be used, and as the soft polisher, a suede pad or nonwoven cloth pad or the like may be used.

In the present invention, the thickness of the thin glass sheet 5 manufactured by the redraw molding method is preferably not more than 110% of the predetermined thickness of the substrate for a magnetic recording medium, and the surface roughness (Ra) of the thin glass sheet 5 is preferably not more than 2 nm.

When the glass substrate prior to lapping and polishing is manufactured using a redraw molding method in the manner described above, a thin glass sheet having superior surface smoothness and minimal strain or warping can be manufactured with comparative ease. In this case, provided the Ra value for the thin glass sheet 5 is not more than 2 nm, the machining allowance during the surface processing of the glass substrate can be reduced as far as possible. Moreover, by ensuring that the thickness of the thin glass sheet 5 is not more than 110% of the predetermined thickness of the substrate for a magnetic recording medium, the magnetic recording medium substrate can be manufactured at a high level of productivity.

In the surface processing step of the present invention, it is preferable that no lapping is used, and that only polishing is conducted, and it is particularly desirable that the polishing processing is completed in only one stage. This enables the substrate for a magnetic recording medium to be manufactured at a very high level of productivity.

In the surface processing of the surfaces of conventional magnetic recording medium substrates, the smoothness of the substrate surfaces prior to processing is poor, and the substrates have also tended to suffer from warping. Accordingly, during surface processing of the substrates, a two-stage lapping step and a two-stage polishing step have usually been performed. In the method of manufacturing a substrate for a magnetic recording medium according to the present invention, surface processing of the substrate can be completed in a one-stage polishing step, meaning the manufacturing process for the magnetic recording medium substrate can be simplified dramatically, and significant cost reductions can be achieved.

### EXAMPLES

The present invention is described below in more detail using an example 1 and comparative example 1. Measurement of the surface roughness Ra (nm) was performed using an atomic force microscope (D3000, manufactured by Digital Instruments).

### Example 1

### (Manufacture of Thin Glass Sheet by Redraw Molding Method)

As an example 1,an apparatus of the structure illustrated in FIG. 1 was used to form a thin glass sheet by a redraw molding method, and a substrate for a magnetic recording medium was then manufactured from this thin glass sheet. The glass base material was a crystallized glass containing oxides of Si, Al, Ca, B, Li, Na and K, having a width of 200 mm, a length of 300 mm, a thickness of 5 mm and an Ra of 2 nm. The bottom end of this glass base material was melted at 700° C., and that bottom end was then pulled downward at a rate of 100 cm/minute, forming a thin glass sheet with a thickness of 0.670 mm. The Ra value of the thus produced thin glass sheet was 2 nm. Further the maximum value for warping of the thin glass sheet within an area of 200 mm square was 30 μm.

### (Edge Processing of Glass Substrate)

A circular disc-shaped glass substrate having an external diameter of 65 mm and an internal diameter of 20 mm was cut from the thin glass sheet of example 1 produced by the above redraw molding method. A diamond hole saw was used for the cutting.

(Surface Processing of Glass Substrate from Redraw Molding Method)

Subsequently, the thin glass sheet was subjected to only the secondary polishing, namely one stage of polishing, of the surface processing described below for the glass substrate produced by a direct press method.

The polishing conditions involved combining a ceria polishing material-containing solution having a solid fraction content of 12% by mass (SHOROX, manufactured by Showa Denko K. K., average grain size: 0.5 μm), a silica polishing material solution having a solid fraction content of 40% by mass (COMPOL, manufactured by Fujimi Incorporated, average grain size: 0.02 μm) and water to form a polishing slurry with a ceria content of 0.6% by mass and a silica content of 0.2% by mass, and then performing polishing using the thus obtained polishing slurry. A 4-way double-sided polishing machine (model 16B, manufactured by Hamai Co., Ltd.) was used as the polishing machine, and suede-type pads (manufactured by Filwel Co., Ltd.) were used as the polishing pads. The slurry supply rate was set to 5 liters/minute, the lower plate rotational speed was set to 40 rpm, the processing pressure was set to 90 g/cm², and the polishing time was 20 minutes.

Further, the machining allowance for the polishing step was 0.035 mm.

The Ra value of the final product (example 1) was 0.15 nm.

### Comparative Example 1

### (Manufacture of Thin Glass Sheet by Direct Press Method)

As a comparative example 1, a thin glass sheet was formed by a direct press method, and a substrate for a magnetic recording medium was then manufactured from this thin glass sheet. The glass base material was a material containing oxides of Li, Si, Al, K, Al, Mg, P, Sb and Zn, and a direct press method was used to manufacture a circular disc-shaped glass substrate with an external diameter of 65 mm. The glass base material was melted at 700° C. and then pressed between two molding dies, and following solidification of the glass, the glass was removed from the dies to complete the manufacture of the circular disc-shaped glass substrate. The thickness of the manufactured glass substrate was 0.850 mm, the Ra value was 10 nm, and the maximum warping across the circular disc of external diameter 65 mm was 25 μm.

### (Edge Processing of Glass Substrate)

The circular disc-shaped thin glass sheet of comparative example 1 produced by the above direct press method was subjected to hole processing to cut a circular disc-shaped glass substrate having an internal diameter of 20 mm. A diamond hole saw was used for the cutting.

(Surface Processing of Glass Substrate from Direct Press Method)

The glass substrate of comparative example 1 manufacture by the above direct press method was subjected to surface processing that included primary lapping, secondary lapping, primary polishing and secondary polishing (final polishing). The conditions for the lapping and polishing are listed below. The machining allowance for the primary lapping was 0.121 mm, the machining allowance for the secondary lapping was 0.060 mm, the machining allowance for the primary polishing was 0.030 mm, and the machining allowance for the secondary polishing was 0.004 mm

### (Primary Lapping Conditions)

Lapping was performed using a diamond lapping plate having a grain size of 12 microns. A 4-way double-sided polishing machine (model 16B, manufactured by Hamai Co., Ltd.) was used as the polishing machine. Water was supplied to the lapping plate during lapping, the lower lapping plate rotational speed was set to 40 rpm, the processing pressure was set to 90 g/cm², and the lapping time was 20 minutes.

### (Secondary Lapping Conditions)

Lapping was performed using a diamond lapping plate having a grain size of 8 microns. A 4-way double-sided polishing machine (model 16B, manufactured by Hamai Co., Ltd.) was used as the polishing machine. Water was supplied to the lapping plate during lapping, the lower lapping plate rotational speed was set to 40 rpm, the processing pressure was set to 90 g/cm², and the lapping time was 20 minutes.

### (Primary Polishing Conditions)

Water was added to a commercially available ceria polishing material (SHOROX, manufactured by Showa Denko K. K., average grain size: 1.0 microns) to form a polishing slurry with a ceria content of 0.6% by mass. A 4-way double-sided polishing machine (model 16B, manufactured by Hamai Co., Ltd.) was used as the polishing machine, and suede-type pads (manufactured by Filwel Co., Ltd.) were used as the polishing pads. The slurry supply rate was set to 5 liters/minute, the lower plate rotational speed was set to 40 rpm, the processing pressure was set to 90 g/cm², and the polishing time was 20 minutes.

### (Secondary Polishing Conditions)

A ceria polishing material-containing solution having a solid fraction content of 12% by mass (SHOROX, manufactured by Showa Denko K. K., average grain size: 0.5 μm) and a silica polishing material solution having a solid fraction content of 40% by mass (COMPOL, manufactured by Fujimi Incorporated, average grain size: 0.08 μm) were added to water to form a polishing slurry with a ceria content of 0.6% by mass and a silica content of 0.2% by mass, and polishing was then conducted using the thus obtained polishing slurry. A 4-way double-sided polishing machine (model 16B, manufactured by Hamai Co., Ltd.) was used as the polishing machine, and suede-type pads (manufactured by Filwel Co., Ltd.) were used as the polishing pads. The slurry supply rate was set to 5 liters/minute, the lower plate rotational speed was set to 40 rpm, the processing pressure was set to 90 g/cm², and the polishing time was 20 minutes.

The Ra value of the final product (comparative example 1) obtained following the above steps was 0.2 nm.

As described above, in example 1,a glass substrate (a substrate for a magnetic recording medium) having no warping and superior surface smoothness was able to be manufactured. Further, in comparative example 1, although a substrate for a magnetic recording medium having a similar Ra value to example 1 was eventually obtained, the number of surface processing steps was considerably more than example 1.

### INDUSTRIAL APPLICABILITY

In the present invention, during the manufacture of a substrate for a magnetic recording medium, warping of the substrate prior to surface processing is reduced, and the surface roughness can be improved dramatically. As a result, lapping and polishing of the substrate surface can be reduced, enabling a marked improvement in the productivity of the glass substrate for a magnetic recording medium, and therefore the invention has a high level of industrial applicability.

### DESCRIPTION OF THE REFERENCE SYMBOLS

1: Glass base material
2: Base material support
3: Heater
4: Pulling roller
5: Thin glass sheet

1. A method of manufacturing a substrate for a magnetic recording medium, said method comprising:
a thin glass sheet formation step of heating and softening a sheet-like glass base material, and heat-stretching said glass base material while pulling said base material downward through space, thereby forming a thin glass sheet,
a glass substrate formation step of cutting a circular disc-shaped glass substrate from said thin glass sheet, and
a surface processing step of subjecting said disc-shaped glass substrate to lapping and/or polishing surface processing.

2. The method of manufacturing a substrate for a magnetic recording medium according to claim 1, wherein in said thin glass sheet formation step, a thickness of said thin glass sheet is not more than 110% of a predetermined thickness of said substrate for a magnetic recording medium, and a surface roughness (Ra) of said thin glass sheet is processed to not more than 2 nm.

3. The method of manufacturing a substrate for a magnetic recording medium according to claim 1, wherein said surface processing step consists of a polishing processing.

4. The method of manufacturing a substrate for a magnetic recording medium according to claim 3, wherein said polishing processing is an one-stage process.

5. The method of manufacturing a substrate for a magnetic recording medium according to claim 2, wherein said surface processing step consists of a polishing processing.

6. The method of manufacturing a substrate for a magnetic recording medium according to claim 5, wherein said polishing processing is an one-stage process.
